(19) United States
(12) Patent Application Publication
(10) Pub. No.: US 2025/0136847 A1
(43) Pub. Date: May 1, 2025

(54) MOISTURE-CURING WINDSCREEN ADHESIVE BASED ON POLYURETHANE

(71) Applicant: SIKA TECHNOLOGY AG, Baar (CH)

(72) Inventors: Geraldine GAILLARD, Zürich (CH); Michele GATTI, Frick (CH)

(73) Assignee: SIKA TECHNOLOGY AG, Baar (CH)

(21) Appl. No.: 18/838,322

(22) PCT Filed: Mar. 20, 2023
(86) PCT No.: PCT/EP2023/056983

§ 371 Date: Aug. 14, 2024

(30) Foreign Application Priority Data
Mar. 25, 2022 (EP) 22164584.9

(51) Int. Cl. C09J 7/32; C09J 11/04; C09J 175/08

(52) U.S. Cl. CPC C09J 7/32; C09J 11/04; C09J 175/08; C09J 2301/306; C09J 2301/408; C09J 2301/50

(57) ABSTRACT

A moisture-curing polyurethane composition includes at least one polyether urethane polymer P1 containing isocyanate groups and having a monomeric diisocyanate content of not more than 0.5% by weight, more than 20% by weight of carbon black, optionally not more than 2% by weight of a room temperature solid polyurethane polymer P2, obtained from the reaction of at least one monomeric diisocyanate with at least one at least semicrystalline polyester polyol or polycarbonate polyol in an NCO/OH ratio of at least 1.3/1, and optionally up to 5% by weight of a polyether urethane polymer P3, obtained from the reaction of at least one monomeric diisocyanate with at least one polyether diol having an average molecular weight Mₙ of not more than 2500 g/mol in an NCO/OH ratio of at least 1.3/1, with the proviso that at least one of the polymers P2 and P3 is present in the composition.

### TECHNICAL FIELD

The invention relates to moisture-curing polyurethane compositions and to the use thereof as elastic adhesives, in particular for the glazing of vehicles.

### PRIOR ART

Curable compositions based on polyurethanes are often used as adhesives for elastic bonds, for example in vehicle construction. One-component moisture-curing systems in particular are popular, particularly on account of their ease of handling. These are used, for example, for the direct glazing of vehicles. For this use, however, it is important that the adhesives have particular properties. As well as good, sustained adhesion on substrates such as vehicle paint, glass and/or screenprinted ceramic, they must also have good initial strength and not have any tendency to slip before curing. For these bonding applications, it is a requirement that the adhesive bond can be exposed to a certain level of mechanical stress immediately after application of the adhesive, for example because the bonded components are to be moved or a fixing aid is to be removed. In order to enable such early stresses, the adhesive bond should indeed have what is called a good initial strength, meaning that it can be subjected to a load in a particular manner until a juncture when the adhesive has not yet chemically cured. This is important, for example, in the case of window bonds in automobile construction, where the window inserted must not slip in the freshly applied adhesive. Nevertheless, however, the adhesives should have sufficiently low viscosity to be able to be conveyed and applied without difficulty by pumps, for example.

One-component polyurethane compositions cure via reaction with moisture, typically air humidity, where the curing proceeds from the outside inward in the applied adhesive via water that diffuses in. The curing rate decreases toward the inside since the water required for the curing must diffuse through the increasingly thicker, reactively crosslinked polymer layer (“skin”). Because of the relatively slow curing, it is often not possible to achieve good initial strengths with conventional one-component polyurethane adhesives. Nevertheless, one-component adhesives are popular with users because they do not require a mixing step as in the case of two- or multi-component compositions.

One means of improving the initial strength of one-component compositions in particular, irrespective of curing, is the addition of relatively large amounts of reinforcing fillers, for example carbon black. Such fillers thicken the adhesive and enable good initial strengths even in the freshly applied state. However, the use of significant amounts of carbon black causes the viscosity of the composition to rise excessively, and, in the case of carbon black contents of more than 20% by weight, it is often no longer possible to pump the composition at all since its viscosity is already much too high, which is problematic for automated conveying and application of the composition in industrial manufacture. This additionally has the effect that very high expression forces are needed to apply the adhesive from a cartridge, for example. WO 2020/201419 A1, WO 2020/030608 A1, and WO 2020/201421, for example, disclose one-component polyurethane adhesives having a carbon black content of less than 20% by weight.

Polyurethane adhesive compositions having good initial strength are likewise obtainable in the form of what are called warm melts, which have a pasty to virtually firm consistency at room temperature and are heated for application, typically to a temperature in the range from 40° C. to 80° C., and are comparatively fluid in the warm state. The initial strength of such an adhesive is obtained not primarily via a chemical reaction but via a significant increase in viscosity in the course of cooling, which arises as a result of physical solidification of a constituent of the adhesive, called the meltable component. The meltable component is a substance which is solid at room temperature and melts and becomes fluid on heating of the adhesive to the application temperature, and solidifies again within a certain period of time when the adhesive is cooled again, for example via crystallization.

Such warm melt adhesives in the form of one-component polyurethane compositions are known, for example, from U.S. Pat. No. 5,367,036. The composition described therein contains, as well as a polyurethane polymer having isocyanate groups, a meltable component in the form of a nonreactive polyurethane polymer, the isocyanate groups of which have been reacted with a monoalcohol to give urethanes. The meltable component brings about a temperature-dependent increase in viscosity and leads to good initial strength. But the use of a nonreactive polyurethane polymer as meltable component has the disadvantage that this is not incorporated into the polyurethane matrix in the course of chemical curing of the composition by means of moisture. The meltable component can therefore migrate out of the cured composition and hence cause unwanted effects on the surface of the bonded substrate, or lead to lower chemical stability, lower mechanical strength and/or poorer bonding properties of the cured composition.

WO 95/00572 A1 describes warm-applicable adhesives containing a liquid reactive prepolymer and a meltable component which is at least partly incompatible therewith, which is preferably a prepolymer having isocyanate end groups. U.S. Pat. Nos. 5,166,302 and 5,173,538 describe warm-applicable, or hot-applicable, adhesive compositions which, as well as a liquid polyurethane polymer, contain a reactive meltable component in the form of a polyurethane polymer having isocyanate groups. The meltable components having isocyanate groups that are described in these patents are incorporated into the polyurethane matrix in the course of chemical curing of the adhesive by means of moisture, which distinctly reduces unwanted effects as occur in the case of nonreactive meltable components. However, they have a tendency to solidify very quickly in the course of cooling and hence to lead to a short open time and/or to cause stresses in the cured adhesive via the reactive crosslinking in the polymer matrix, which can have an adverse effect on the strength of the adhesive bond. Further disadvantages of the reactive meltable components described are that they only have limited storage stability and can crosslink prematurely by the reactive groups, which adversely affects the viscosity and solidification characteristics thereof. In addition, they are prone to cold ambient temperatures on application, for instance a factory hall in winter, since the warmed composition in such cases cools down too rapidly and solidifies too quickly.

WO 2018/132242 A1 describes a developed adhesive composition of this kind, which comprises a polyester urethane polymer based on diphenylmethane 4,4′-diisocyanate (MDI) and a polyester polymer and can be applied at room temperature and nevertheless has a reduced tendency to slippage of a substrate bonded therewith as a result of the resultant improvement in initial strength.

Reactive meltable components based on polyester urethanes as just described, because of their advantageous properties, are currently the additives most commonly used in such polyurethane adhesives for improvement of initial strength, often in combination with carbon black.

However, all the known polyurethane compositions containing such a polyester urethane polymer as meltable component still have inherent disadvantages. In particular, the amounts of this polyester urethane polymer required for sufficient initial strength and slip stability in the adhesive applications described have a tendency to increase delamination, i.e. to cause loss of adhesion under stress on the bond. It is possible to minimize the amount of the meltable component by additional use of reinforcing fillers such as carbon black, which can solve this problem. But this will inevitably increase viscosity and hence the required expression force on application, which is undesirable. Moreover, it is necessary to compress bonds with high forces in order to establish sufficient facial contact of the adhesive with the substrates.

It has not yet been satisfactorily possible to provide a one-component polyurethane composition suitable as elastic structural adhesive in the manufacturing industry, which can be applied or pumped readily with low expression force, at the same time has very good initial strength that prevents slippage of freshly bonded substrates, and additionally enables stable bonds without delamination under mechanical stress.

### SUMMARY OF THE INVENTION

It is an object of the present invention to provide one-component moisture-curing polyurethane compositions having good initial strength, which can be applied at room temperature or in heated form, which at the same time have sufficiently low viscosity for problem-free application and conveying by means of pumps, and the bonding of which does not lead to delamination under mechanical stress. In addition, the composition is to have very good adhesion to substrates such as automotive paint, glass and screenprinted ceramic, is to show robust mechanical properties even after heated storage, and is to require low compression forces in the bonding of substrates.

This object is achieved by the moisture-curing composition as described in claim 1. The composition contains at least one polyether urethane polymer P1 containing isocyanate groups and having a monomeric diisocyanate content of not more than 0.5% by weight, obtained from the reaction of at least one monomeric diisocyanate with at least one polyether polyol having an average molecular weight Mₙ of more than 2500 g/mol in an NCO/OH ratio of at least 3/1, and subsequent removal of a majority of the monomeric diisocyanates by means of a suitable separation method, and more than 20% by weight of carbon black, based on the overall composition. In addition, the composition contains a room temperature solid polyurethane polymer P2 and/or a linear, short-chain polyether urethane polymer P3 in small amounts.

The composition of the invention has exceptionally good processibility at room temperature with comparatively low expression forces and has very low initial strength with a low tendency to slippage prior to curing and a very low tendency to delamination of a bond after curing of the composition as adhesive.

It is a particularly surprising fact that the composition of the invention has unexpectedly good processing properties even though it has a high carbon black content.

For improvement of initial strength, sag resistance and threading, moisture-curing polyurethane adhesives, especially for motor vehicle construction, often additionally comprise a meltable component, typically a small amount of a room temperature solid polyurethane polymer based on a crystalline polyester polyol. However, the meltable component increases the expression force for the adhesive at room temperature and under cold conditions, and sag resistance is highly shear-dependent, which can lead to problems in production and application. Surprisingly, the composition of the invention is unexpectedly easily expressible even when it additionally contains small amounts of a room temperature solid polyurethane polymer P2, with the rheological properties being significantly less shear-dependent. In particular, the composition of the invention enables adhesives where such a meltable component can be used in a much smaller amount than in the prior art or can be omitted entirely without impairing initial strength.

The composition of the invention, at room temperature or in the heated state, enables applicable moisture-curing elastic polyurethane adhesives having improved application properties, in particular particularly good expressibility, but at the same time exceptionally high initial strength, with unchanged good properties in relation to storage stability, curing rate, blistering, strength, extensibility, elasticity and hazardous substance classification by comparison with the prior art. The composition is thus particularly suitable as elastic adhesive in motor vehicle construction, especially for use of elastically bonded windshields on automobiles in direct glazing applications.

Further aspects of the invention are the subject of further independent claims. Particularly preferred embodiments of the invention are the subject of the dependent claims.

### Ways of Executing the Invention

The invention provides a moisture-curing polyurethane composition comprising
at least one polyether urethane polymer P1 containing isocyanate groups and having a monomeric diisocyanate content of not more than 0.5% by weight, preferably not more than 0.3% by weight, more preferably not more than 0.2% by weight, based on polymer P1, obtained from the reaction of at least one monomeric diisocyanate with at least one polyether polyol having an average molecular weight Mₙ of more than 2500 g/mol, preferably 2750 to 20 000 g/mol, more preferably 3′000 to 15′000 g/mol, especially 4000 to 10 000 g/mol, in an NCO/OH ratio of at least 3/1, and subsequent removal of a majority of the monomeric diisocyanates by means of a suitable separation method, and
more than 20% by weight of carbon black, preferably between 20.5% and 25% by weight of carbon black, especially between 21% and 24% by weight of carbon black, based on the overall composition, and
optionally not more than 2% by weight, preferably between 0.5% and 1.5% by weight, of a room temperature solid polyurethane polymer P2, based on the overall composition, obtained from the reaction of at least one monomeric diisocyanate with at least one at least semicrystalline polyester polyol or polycarbonate polyol in an NCO/OH ratio of at least 1.3/1, and
optionally up to 5% by weight, preferably between 0.5% and 2% by weight, of a polyether urethane polymer P3, based on the overall composition, obtained from the reaction of at least one monomeric diisocyanate with at least one polyether diol having an average molecular weight Mₙ of not more than 2500 g/mol in an NCO/OH ratio of at least 1.3/1,
   with the proviso that at least one of the polymers P2 and P3 is present in the composition.

“Monomeric diisocyanate” refers to an organic compound having two isocyanate groups separated from one another by a divalent hydrocarbyl radical having 4 to 15 carbon atoms.

A “polyether urethane polymer” refers to a polymer having ether groups as repeat units and additionally containing urethane groups.

A “polyester urethane polymer” refers to a polymer having ester groups as repeat units and additionally containing urethane groups.

“NCO content” refers to the content of isocyanate groups in percent by weight based on the whole polymer.

“Molecular weight” refers to the molar mass (in grams per mole) of a molecule or a molecule residue. “Average molecular weight” refers to the number-average molecular weight (Mₙ) of a polydisperse mixture of oligomeric or polymeric molecules or molecule residues. It is determined by gel-permeation chromatography (GPC) against polystyrene as standard.

A substance or composition is referred to as “storage-stable” or “storable” when it can be stored at room temperature in a suitable container over a prolonged period, typically over at least 3 months to up to 6 months or more, without any change in its application or use properties to a degree of relevance for the use thereof as a result of the storage.

A composition referred to as a “one-component” composition is one in which all constituents of the composition are in the same container and which is storage-stable as is.

“Room temperature” refers to a temperature of 23° C.

All industry standards and norms mentioned in this document relate to the versions valid at the date of first filing.

Percentages by weight (% by weight) refer to proportions by mass of a constituent of a composition or a molecule, based on the overall composition or the overall molecule, unless stated otherwise. The terms “mass” and “weight” are used synonymously in the present document.

The moisture-curing composition contains at least one polyether urethane polymer P1 containing isocyanate groups and having a monomeric diisocyanate content of not more than 0.5% by weight, obtained from the reaction of at least one monomeric diisocyanate with at least one polyether polyol having an average molecular weight Mₙ of more than 2500 g/mol in an NCO/OH ratio of at least 3/1, and subsequent removal of a majority of the monomeric diisocyanates by means of a suitable separation method.

It is preferably at least one polyether urethane polymer P1 having a content of at least 80% by weight of 1,2-propyleneoxy units in the polyether segment.

The polyether urethane polymer P1 preferably comprises 80% to 100% by weight of 1,2-propyleneoxy units and 0% to 20% by weight of 1,2-ethyleneoxy units in the polyether segment.

The polyether urethane polymer P1 preferably has an average NCO functionality in the range from 1.5 to 3.5, preferably 1.8 to 3.2.

The polyether urethane polymer P1 preferably has an NCO content in the range from 1% to 5% by weight, especially 1% to 3% by weight.

The polyether urethane polymer P1 preferably has an average molecular weight Mₙ in the range from 3000 to 20 000 g/mol, preferably 4500 to 15 000 g/mol.

The polyether urethane polymer P1 preferably has a viscosity at 20° C. in the range from 5 to 300 Pa·s, more preferably 5 to 200 Pa·s, especially 5 to 100 Pa·s. The viscosity is determined here with a cone-plate viscometer having a cone diameter 25 mm, cone angle 1°, cone tip-plate distance 0.5 mm, at a shear rate of 50 s⁻¹.

The preferred polyether urethane polymers P1 enable efficiently processible moisture-curing compositions having high elasticity and extensibility coupled with high strength.

The polyether urethane polymer P1 is obtained from the reaction of at least one monomeric diisocyanate and at least one suitable polyether polyol having an average molecular weight Mₙ of more than 2500 g/mol. Preferred forms of the polyether polyol are described further down.

The reaction is preferably carried out with exclusion of moisture at a temperature within a range from 20 to 160° C., especially 40 to 140° C., optionally in the presence of suitable catalysts.

The NCO/OH ratio is at least 3/1, preferably in the range from 3/1 to 10/1. The monomeric diisocyanate remaining in the reaction mixture after reaction of the OH groups is removed, in particular by distillation.

The NCO/OH ratio in the reaction is preferably in the range from 3/1 to 10/1, especially 4/1 to 7/1, and the resultant polyether urethane polymer containing isocyanate groups, after distillation, contains not more than 0.5% by weight, preferably not more than 0.3% by weight and more preferably not more than 0.2% by weight of monomeric diisocyanate, based on the distillation residue containing the polyether urethane polymer.

Polyether urethane polymers that are not prepared by the process described above and have a lower NCO/OH ratio, i.e. 2/1 for example, are unsuitable as polymer P1 since they are surprisingly incapable of bringing about the inventive properties of the composition. It should be noted in this connection that the NCO/OH ratio in the preparation of polyurethane polymers has a major influence on the chain length and polydispersity of the resulting polyurethane polymers.

Suitable monomeric diisocyanates for the preparation of the polyether urethane polymer P1 are commercially available aromatic, aliphatic or cycloaliphatic diisocyanates, especially diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), naphthalene 1,5-diisocyanate (NDI), hexane 1,6-diisocyanate (HDI), 2,2(4),4-trimethylhexamethylene 1,6-diisocyanate (TMDI), cyclohexane 1,3- or 1,4-diisocyanate, 1-isocyanato-3,3,5-trimethyl-5-isocyanatomethylcyclohexane (isophorone diisocyanate or IPDI), perhydro(diphenylmethane 2,4′- or 4,4′-diisocyanate) (HMDI), 1,3- or 1,4-bis(isocyanatomethyl)cyclohexane, m- or p-xylylene diisocyanate (XDI), or mixtures thereof.

Among these, preference is given to MDI, TDI, HDI or IPDI. Particular preference is given to IPDI or MDI.

Most preferred is MDI, especially diphenylmethane 4,4′-diisocyanate (4,4′-MDI). This 4,4′-MDI is especially of a quality that contains only small fractions of diphenylmethane 2,4′- and/or 2,2′-diisocyanate and is solid at room temperature.

The isocyanate groups of the polyether urethane polymer P1 are thus preferably derived from diphenylmethane 4,4′-diisocyanate. Such a polymer cures particularly rapidly and enables particularly high strengths.

Suitable polyether polyols for the preparation of the polyether urethane polymer P1 are polyether polyols, in particular having at least 80% by weight of 1,2-propyleneoxy units in the polyether segment, especially polyoxypropylene diols or polyoxypropylene triols, or what are called ethylene oxide-terminated (EO-capped or EO-tipped) polyoxypropylene diols or triols. The latter are polyoxyethylene/polyoxypropylene copolyols which are obtained especially by further alkoxylating polyoxypropylene diols or triols with ethylene oxide on conclusion of the propoxylation reaction, with the result that they have primary hydroxyl groups.

Preference is given to polyether polyols having an OH number in the range from 6 to 280 mg KOH/g, especially 7.5 to 112 mg KOH/g.

Preference is given to polyether polyols having an average molecular weight Mₙ in the range from 2750 to 20 000 g/mol, preferably 3000 to 15 000 g/mol, especially 4000 to 10 000 g/mol.

Preference is given to polyether polyols having an average OH functionality in the range from 1.6 to 3.

In the preparation of the polyether urethane polymer P1 containing isocyanate groups, it is also possible to include proportions of di- or polyfunctional alcohols.

More preferably, the polyether urethane polymer P1 is obtained from the reaction of at least one monomeric diisocyanate and at least one optionally ethylene oxide-terminated polyoxypropylene diol or triol having an OH number in the range from 7.5 to 112 mg KOH/g, especially 11 to 58 mg KOH/g.

A preferred separation method for the removal of monomeric diisocyanate is a distillative method, especially thin-film distillation or short-path distillation, preferably with application of reduced pressure.

Particular preference is given to a multistage method in which the monomeric diisocyanate is removed in a short-path evaporator with a jacket temperature in the range from 120° C. to 200° C. and a pressure of 0.001 to 0.5 mbar.

In the case of 4,4′-MDI, which is preferred as monomeric diisocyanate, distillative removal is particularly demanding. It has to be ensured, for example, that the condensate does not solidify and block the system. Preference is given to operating at a jacket temperature in the range from 160° C. to 200° C. at 0.001 to 0.5 mbar and condensing the monomer removed at a temperature in the range from 40° C. to 60° C.

Preference is given to reacting the monomeric diisocyanate with the polyether polyol and subsequently removing the majority of the monomeric diisocyanate remaining in the reaction mixture without the use of solvents or entraining agents.

The monomeric diisocyanate removed after the reaction is preferably reused subsequently, i.e. used again for the preparation of polymer containing isocyanate groups.

Polymer P1 preferably comprises at least one polymer P1a obtained from a polyether diol, and at least one polymer P1b obtained from a polyether triol. Such a polymer P1a is linear and enables good extensibility. In combination with such a polymer P1b, particularly good strength is additionally obtained.

More preferably, the polyether urethane polymer P1 contains a polymer P1a having an NCO content in the range from 1% to 2.5% by weight, especially 1.3% to 2.1% by weight, and a monomeric diisocyanate content of not more than 0.3% by weight, obtained from the reaction of at least one monomeric diisocyanate with a polyether diol having an OH number in the range from 13 to 38 mg KOH/g, especially 22 to 32 mg KOH/g, in an NCO/OH ratio of at least 3/1 and subsequent removal of a majority of the monomeric diisocyanates by means of a suitable separation method. A preferred monomeric diisocyanate is IPDI or 4,4′-MDI, especially 4,4′-MDI.

In addition, the polyether urethane polymer P1 more preferably comprises a polymer P1b having an NCO content in the range from 1% to 2.5% by weight, especially 1.3% to 2.1% by weight, and a monomeric diisocyanate content of not more than 0.3% by weight, which is obtained from the reaction of at least one monomeric diisocyanate and a polyether triol having an average OH functionality in the range from 2.2 to 3 and an OH number in the range from 20 to 42 mg KOH/g in an NCO/OH ratio of at least 3/1 and subsequent removal of a majority of the monomeric diisocyanates by means of a suitable separation method. A preferred monomeric diisocyanate is IPDI or 4,4′-MDI, especially 4,4′-MDI.

In addition, a more preferred polyether urethane polymer P1 is a mixture of these two particularly preferred polyether urethane polymers P1a and P1b as just described.

The moisture-curing composition preferably contains 20% to 60% by weight, especially 25% to 50% by weight, of polyether urethane polymer P1.

In the case of a mixture of P1a and polymer P1b in the polyether urethane polymer P1, there is preferably a weight ratio of P1a:P1b of 5:1 to 1:5, preferably 4:1 to 1:2, more preferably 4:1 to 1:1.

The moisture-curing composition additionally optionally contains not more than 2% by weight of a room temperature solid polyurethane polymer P2, based on the overall composition, obtained from the reaction of at least one monomeric diisocyanate with at least one at least semicrystalline polyester polyol or polycarbonate polyol in an NCO/OH ratio of at least 1.3/1.

Such a polymer P2 is firstly suitable for adhesives that are applied in the heated state, for example at a temperature of about 60° C., and very quickly after application have a high initial strength, such that the bonded parts are self-supporting and need not be fixed. Polymer P2 here is in molten form in the heated adhesive on application, and crystallizes as the applied adhesive cools down. In addition, such a polymer P2 is suitable for adhesives that are applied at ambient temperature, where the meltable component is in crystallized form and results in an elevated sag resistance. However, this meltable component in the form of the polymer P2 present is difficult to handle, and the sag resistance achieved therewith is highly shear-dependent, which can lead to problems in production and application. Moreover, relatively high amounts of polymer P2 make it difficult to express the adhesive at room temperature and at cold ambient or adhesive temperatures.

In addition, not more than a maximum of 2% by weight of polymer P2 should be used in the composition. A polymer P2 content of more than 2% by weight, based on the overall composition, leads firstly to an increased risk of delamination of a bonded substrate under stress, i.e. a loss of adhesion. Moreover, it leads to unwanted increase in the compression force required on bonding when the material cools down. Moreover, it leads to a drastic shortening of the open time on cooling.

The present invention makes it possible, especially with use of polymer P3 as described further down, to provide adhesives having an excellent tendency to slippage and maximum initial strength, which can be formulated with not more than 2% by weight of polymer P2 or other meltable components, and therefore do not have these disadvantages.

A preferred embodiment of the composition of the invention contains between 0.5% and 1.5% by weight of polymer P2, based on the overall composition. With this amount of polymer P2, it is possible to utilize the advantageous properties of such room temperature solid polymers without occurrence of the abovementioned disadvantages to a significant degree.

A preferred embodiment of the composition of the invention contains no polymer P2 and only polymer P3. Such a composition has particularly good suitability for low ambient temperatures on application and nevertheless shows a particularly low tendency to delamination of the bond. Nevertheless, it has a sufficiently high initial strength and sufficiently low tendency to slippage on application.

The at least one polyurethane polymer P2 is obtainable by the reaction of at least one at least partly crystalline polyester polyol or polycarbonate polyol in an NCO/OH ratio of at least 1.3/1 with at least one monomeric diisocyanate by known methods.

The monomeric diisocyanate used for the reaction is preferably diphenylmethane 4,4′-diisocyanate (4,4′-MDI), diphenylmethane 2,4′-diisocyanate (2,4′-MDI), tolylene 2,4-diisocyanate or mixtures thereof with tolylene 2,6-diisocyanate (TDI), 1-isocyanato-3,3,5-trimethyl-5-isocyanatomethylcyclohexane (IPDI) or hexane 1,6-diisocyanate (HDI). These diisocyanates are easily obtainable and inexpensive, and enable good mechanical strength. It is also possible to use a combination of two or more of these monomeric diisocyanates.

A particularly preferred monomeric diisocyanate is IPDI. Such a polymer P2 is particularly suitable in moisture-curing compositions having particularly high light stability.

Most preferred as monomeric diisocyanate is 4,4′-MDI. This 4,4′-MDI is especially of a quality that contains only small fractions of diphenylmethane 2,4′- and/or 2,2′-diisocyanate and is solid at room temperature. Such a polymer P2 enables particularly rapid curing and high strengths.

The reaction of at least one monomeric diisocyanate and the at least one semicrystalline polyester polyol or polycarbonate polyol for preparation of polymer P2 is preferably conducted with exclusion of moisture at a temperature in the range from 20 to 160° C., especially 40 to 140° C., optionally in the presence of suitable catalysts.

The NCO/OH ratio is preferably in the range from 1.3/1 to 10/1. The monomeric diisocyanate remaining in the reaction mixture after reaction of the OH groups can be removed, in particular by distillation.

If excess monomeric diisocyanate is removed by means of distillation, the NCO/OH ratio in the reaction is preferably in the range from 3/1 to 10/1, especially 4/1 to 7/1, and the resultant polymer containing isocyanate groups, after the distillation, preferably contains not more than 0.5% by weight, more preferably not more than 0.3% by weight, of monomeric diisocyanate.

If no excess monomeric diisocyanate is removed from the polymer, the NCO/OH ratio in the reaction is preferably in the range from 1.3/1 to 2.5/1. Such a polymer especially contains not more than 3% by weight, preferably not more than 2% by weight, of monomeric diisocyanate.

Particularly suitable polyols for preparation of a polyurethane polymer P2 are firstly polyester polyols, also called oligoesterols, prepared, for example, from di- to trivalent alcohols, for example ethane-1,2-diol, diethylene glycol, propane-1,2-diol, dipropylene glycol, butane-1,4-diol, pentane-1,5-diol, hexane-1,6-diol, neopentyl glycol, glycerol, 1,1,1-trimethylolpropane or mixtures of the aforementioned alcohols with organic dicarboxylic acids or the anhydrides or esters thereof, for example succinic acid, glutaric acid, adipic acid, pimelic acid, suberic acid, azelaic acid, sebacic acid, dodecanedicarboxylic acid, maleic acid, fumaric acid, phthalic acid, isophthalic acid, terephthalic acid and hexahydrophthalic acid or mixtures of the aforementioned acids, and polyester polyols formed from lactones, for example ε-caprolactone.

Preference is given to amorphous, semicrystalline and crystalline polyester di- and triols that are liquid at room temperature, especially polyester diols. Suitable polyester diols that are liquid at room temperature are solid not far below room temperature, for example at temperatures between 0° C. and 25° C., and, like amorphous polyester polyols, are always used in combination with at least one semicrystalline or crystalline polyester polyol.

Particularly preferred polyester diols are adipic acid/hexanediol polyesters, azelaic acid/hexanediol polyesters and dodecanedicarboxylic acid/hexanediol polyesters having a melting point in the range from 40° C. to 80° C., especially 50° C. to 70° C.

Particularly suitable polyols for preparation of a polyurethane polymer P2 are secondly polycarbonate polyols as obtainable by reaction for example of the abovementioned alcohols used to form the polyester polyols with dialkyl carbonates such as dimethyl carbonate, diaryl carbonates such as diphenyl carbonate, or phosgene. Amorphous, semicrystalline or crystalline polycarbonate diols that are liquid at room temperature are especially suitable. Suitable polycarbonate diols that are liquid at room temperature are solid not far below room temperature, for example at temperatures between 0° C. and 25° C., and, like amorphous polycarbonate polyols, are always used in combination with at least one semicrystalline or crystalline polycarbonate polyol.

Preference is given to polyester diols and polycarbonate diols.

Suitable polyester diols are especially OH-functional polyesters of adipic acid or sebacic acid or dodecanedicarboxylic acid with butane-1,4-diol or hexane-1,6-diol.

Suitable polycarbonate diols are especially OH-functional polycarbonates of hexane-1,6-diol.

Such a polymer P2 is typically solid at room temperature and has at least partially crystalline character.

The polyurethane polymer P2 is solid at room temperature and preferably has a melting point in the range from 40° C. to 80° C., especially in the range from 50° C. to 70° C.

The polyurethane polymer P2 has an average molecular weight Mₙ of preferably 500 g/mol or higher. In particular, the polyurethane polymer P2 has an average molecular weight Mₙ in the range from 1000 to 30 000 g/mol, preferably 2000 to 10 000 g/mol. In addition, the polyurethane polymer P2 preferably has an average functionality in the range from 1.8 to 2.2.

The moisture-curing composition also optionally contains up to 5% by weight of a polyether urethane polymer P3, based on the overall composition, obtained from the reaction of at least one monomeric diisocyanate with at least one polyether diol having an average molecular weight Mₙ of not more than 2500 g/mol in an NCO/OH ratio of at least 1.3/1.

The use of polymer P3 is optional but preferred, since polymer P3 leads to an improvement in the properties of the invention, for example to an even lower tendency to slippage and an even higher initial strength. In particular, polymer P3 may bring the advantages of polymer P2, without its disadvantages. A combination of polymer P3 and small amounts of polymer P2 can lead to particularly good properties with regard to slippage characteristics and initial strength.

The composition preferably contains between 0.5% and 2% by weight of polymer P3, based on the overall composition. More than 2% by weight of polymer P3 does not have direct adverse effects, but does not lead to any further significant improvement in properties.

Polymer P3 is prepared from at least one polyether diol having an average molecular weight Mₙ of not more than 2500 g/mol in an NCO/OH ratio of at least 1.3/1.

All polyether diols having these properties are suitable.

Preference is given to polyoxypropylene diols having an OH number of 50 to 300 mg KOH/g.

A suitable example is Acclaim® 2200 N (Covestro) having an OH number of 54 to 58 mg KOH/g and an average molecular weight Mₙ of about 2000 g/mol. Likewise suitable and preferred is Voranol® P 400 (Dow) having an OH number of 260 mg KOH/g and an average molecular weight Mₙ of about 431 g/mol. With polymers P3 based on this diol, it is possible to achieve particularly low slippage characteristics (slipdown) and particularly low compression forces when the composition is used as an adhesive.

The most preferred polyether diols for polymer P3 are poly(oxy-1,4-butylene)diols.

A poly(oxy-1,4-butylene)diol is a polyether diol having 1,4-butyleneoxy units. Such a diol is also referred to as polytetramethylene ether glycol (PTMEG or PTMG). With polymers P3 based on this diol, it is possible to achieve particularly low expression forces and hence particularly good pumpability and applicability when the composition is used as adhesive.

The at least one polyol is more preferably a poly(oxy-1,4-butylene)diol or a mixture of poly(oxy-1,4-butylene)diols.

More preferably, the isocyanate-functional polymer is obtained by the reaction of isophorone diisocyanate with a poly(oxy-1,4-butylene)diol or a mixture of poly(oxy-1,4-butylene)diols, optionally in combination with at least one chain extender.

The poly(oxy-1,4-butylene)diol or a mixture of poly(oxy-1,4-butylene)diols preferably has an average total OH number in the range from 80 to 200 mg KOH/g, preferably 100 to 180 mg KOH/g.

If a mixture of two or more poly(oxy-1,4-butylene)diols is used, the total average OH number is the average of the OH numbers of the diols in the mixture.

The poly(oxy-1,4-butylene)diol is preferably selected from the group consisting of
a poly(oxy-1,4-butylene)diol having an OH number in the range from 170 to 180 mg KOH/g and an average molecular weight Mₙ of about 650 g/mol,
a poly(oxy-1,4-butylene)diol having an OH number in the range from 108 to 118 mg KOH/g and an average molecular weight Mₙ of about 1000 g/mol,
a poly(oxy-1,4-butylene)diol having an OH number in the range from 75 to 85 mg KOH/g and an average molecular weight Mₙ of about 1400 g/mol,
a poly(oxy-1,4-butylene)diol having an OH number in the range from 60 to 65 mg KOH/g and an average molecular weight Mₙ of about 1800 g/mol,
a poly(oxy-1,4-butylene)diol having an OH number in the range from 50 to 60 mg KOH/g and an average molecular weight Mₙ of about 2000 g/mol,
   and mixtures thereof.

Such diols are commercially available, for example in the form of Terathane® 650, Terathane® 1000, Terathane® 1400, Terathane® 1800 or Terathane® 2000 (all from Invista), or of PolyTHF 650, PolyTHF 1000, PolyTHF 1400, PolyTHF 1800 or PolyTHF 2000 (all from BASF).

Suitable monomeric diisocyanates for polymer P3 are the commercially available aromatic, aliphatic or cycloaliphatic diisocyanates already mentioned.

The monomeric diisocyanate used for the reaction is preferably diphenylmethane 4,4′-diisocyanate (4,4′-MDI), diphenylmethane 2,4′-diisocyanate (2,4′-MDI), tolylene 2,4-diisocyanate or mixtures thereof with tolylene 2,6-diisocyanate (TDI), 1-isocyanato-3,3,5-trimethyl-5-isocyanatomethylcyclohexane (IPDI) or hexane 1,6-diisocyanate (HDI). These diisocyanates are easily obtainable and inexpensive, and enable good mechanical strength. It is also possible to use a combination of two or more of these monomeric diisocyanates.

A particularly preferred monomeric diisocyanate is IPDI. Such a polymer P3 is particularly suitable in moisture-curing compositions having particularly high light stability.

Most preferred as monomeric diisocyanate for polymer P3 is 4,4′-MDI. This 4,4′-MDI is especially of a quality that contains only small fractions of diphenylmethane 2,4′- and/or 2,2′-diisocyanate and is solid at room temperature. Such a polymer P3 enables particularly rapid curing and high strengths.

The reaction of at least one monomeric diisocyanate and the polyether diol for preparation of polymer P3 is preferably conducted with exclusion of moisture at a temperature in the range from 20 to 160° C., especially 40 to 140° C., optionally in the presence of suitable catalysts.

The NCO/OH ratio is preferably in the range from 1.3/1 to 10/1. The monomeric diisocyanate remaining in the reaction mixture after reaction of the OH groups can be removed, in particular by distillation.

If excess monomeric diisocyanate is removed by means of distillation, the NCO/OH ratio in the reaction is preferably in the range from 3/1 to 10/1, especially 4/1 to 7/1, and the resultant polymer P3 containing isocyanate groups, after the distillation, preferably contains not more than 0.5% by weight, more preferably not more than 0.3% by weight, of monomeric diisocyanate.

If no excess monomeric diisocyanate is removed from the polymer, the NCO/OH ratio in the reaction is preferably in the range from 1.3/1 to 2.5/1. Such a polymer especially contains not more than 3% by weight, preferably not more than 2% by weight, of monomeric diisocyanate.

Polymer P3 preferably has a viscosity at 20° C. of not more than 1000 Pa·s, especially not more than 500 Pa·s. The viscosity at 20° C. is preferably in the range from 10 to 1000 Pa·s, especially 10 to 500 Pa·s. The viscosity is determined here with a cone-plate viscometer having a cone diameter 25 mm, cone angle 1°, cone tip-plate distance 0.5 mm, at a shear rate of 50 s⁻¹.

Polymer P3 preferably has an NCO content in the range from 3% to 12% by weight, more preferably 3.5% to 10% by weight, especially preferably 4% to 9.5% by weight, in particular 4.5% to 9% by weight.

Polymer P3 preferably has a monomeric diisocyanate content of not more than 0.5% by weight and is obtained from the reaction of at least one monomeric diisocyanate and the polyether diol in an NCO/OH ratio of at least 3/1, followed by removal of a majority of the monomeric diisocyanate by means of a suitable separation method.

Such a polymer P3 is of particularly low viscosity, which makes it easier to handle, and it is particularly suitable for use in compositions having less than 0.1% by weight of monomeric diisocyanates; these are safe to handle even without special safety precautions and can be sold in many countries without hazardous substance classification.

The NCO/OH ratio in the reaction is preferably in the range from 3/1 to 10/1, more preferably 3/1 to 8/1, especially 4/1 to 7/1.

The monomeric diisocyanate content is preferably not more than 0.3% by weight, especially not more than 0.2% by weight.

A preferred separation method for the removal of monomeric diisocyanate is a distillative method, especially thin-film distillation or short-path distillation, preferably with application of reduced pressure.

Particular preference is given to a multistage method in which the monomeric diisocyanate is removed in a short-path evaporator with a jacket temperature in the range from 120° C. to 200° C. and a pressure of 0.001 to 0.5 mbar.

Preference is given to reacting the monomeric diisocyanate with the hydrophobic diol and subsequently removing the majority of the monomeric diisocyanate remaining in the reaction mixture without the use of solvents or entraining agents.

The monomeric diisocyanate removed after the reaction is preferably reused subsequently, i.e. used again for the preparation of polymer containing isocyanate groups.

The polyether urethane polymer P1 and any polyurethane polymer P2 present and any polyether urethane polymer P3 present are prepared separately from one another. They are thus mixed with one another only after preparation, especially only in the moisture-curing composition of the invention.

The moisture-curing composition preferably comprises, aside from the polymers P1 and optionally P2 and P3, only a small amount of further polymers containing isocyanate groups, especially not more than 20 parts by weight, preferably not more than 15 parts by weight, especially not more than 10 parts by weight, most preferably not more than 5 parts by weight, of further polymers containing isocyanate groups, based on 100 parts by weight of the sum total of polymers P1 and P2 and P3.

The moisture-curing composition as claimed in claim 11 or 12, characterized in that the composition contains at least 0.5% by weight of polymer P2 and/or at least 0.5% by weight of polymer P3, based on the overall composition.

The moisture-curing composition contains more than 20% by weight of carbon black, based on the overall composition, preferably between 20.5% and 25% by weight of carbon black, especially between 21% and 24% by weight of carbon black, based on the overall composition.

Suitable carbon blacks are all of those that are produced industrially and are normally used in polyurethane compositions.

Carbon black is a reinforcing filler that improves initial strength and mechanical properties and additionally improves stability to light and oxidation.

It is normally difficult to introduce more than 20% by weight of carbon black into such compositions without greatly impairing application properties, for example expression forces required. However, it has been found that, surprisingly, the use of polymers P1 enables much higher amounts of carbon black without impairing application properties.

The moisture-curing composition preferably additionally comprises at least one further constituent selected from silane adhesion promoters, blocked amines, diisocyanate oligomers, drying agents, catalysts and stabilizers.

In one embodiment of the invention, the moisture-curing composition preferably additionally comprises at least one blocked amine.

A suitable blocked amine preferably has at least one aldimino group or oxazolidino group. On contact with moisture, it is hydrolyzed with release of the amino group and reacts with available isocyanate groups, and can promote rapid, blister-free curing, a particularly nontacky surface and/or particularly good mechanical properties.

Preferred oxazolidines are monooxazolidines or bisoxazolidines, especially those derived from isobutyraldehyde, benzaldehyde or substituted benzaldehyde, especially benzaldehyde substituted in the para position by an optionally branched alkyl group having 10 to 14 carbon atoms.

Particular preference is given to monooxazolidines derived from N-alkylethanolamines such as N-n-butylethanolamine, or bisoxazolidines from the reaction of OH-functional monooxazolidines derived from diethanolamine with diisocyanates, especially hexane 1,6-diisocyanate.

Suitable aldimines are especially di- or trialdimines from the reaction of commercial primary di- or triamines with non-enolizable aldehydes. These are aldehydes that do not have a hydrogen atom in the alpha position to the carbon atom of the aldehyde group.

Preferred blocked amines are selected from aldimines of the formula (I) and (II)

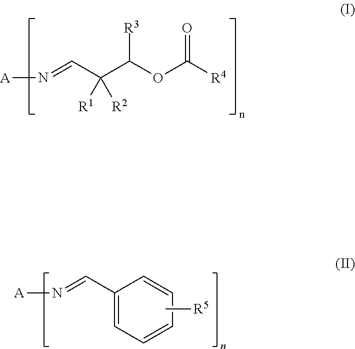

where
n is 2 or 3,
A is an n-valent hydrocarbyl radical optionally including ether oxygen and having a molecular weight in the range from 28 to 6′000 g/mol,
R¹ and R² are each independently a monovalent hydrocarbyl radical having 1 to 12 carbon atoms, or together are a divalent hydrocarbyl radical having 4 to 12 carbon atoms which is part of an optionally substituted carbocyclic ring having 5 to 8, preferably 6, carbon atoms,
R³ is a hydrogen radical or a linear or branched alkyl, arylalkyl or alkoxycarbonyl radical having 1 to 12 carbon atoms,
R⁴ is a hydrogen radical or a monovalent hydrocarbyl radical having 1 to 20 carbon atoms, and
R⁵ is an alkyl or alkoxy radical having 6 to 20 carbon atoms.

A is preferably an aliphatic, cycloaliphatic or arylaliphatic radical, especially having a molecular weight in the range from 28 to 500 g/mol, especially a radical selected from the group consisting of 1,6-hexylene, (1,5,5-trimethylcyclohexan-1-yl)methane-1,3,4(2)-methyl-1,3-cyclohexylene, 1,3-cyclohexylenebis(methylene), 1,4-cyclohexylenebis(methylene), 1,3-phenylenebis(methylene), 1,2-cyclohexylene, 1,3-cyclohexylene, 1,4-cyclohexylene, methylenebis(2-methylcyclohexan-4-yl), (bicyclo[2.2.1]heptane-2,5(2,6)-diyl)dimethylene, (tricyclo[5.2.1.0^{2,6}]decan-3(4),8(9)-diyl)dimethylene, α,ω-polyoxypropylene having an average molecular weight Mₙ in the range from 170 to 500 g/mol and trimethylolpropane- or glycerol-started tris(ω)-polyoxypropylene) having an average molecular weight Mₙ in the range from 330 to 500 g/mol.

Preferably, R¹ and R² are each methyl.

Preferably, R³ is a hydrogen radical.

Preferably, R⁴ is methyl or undecyl.

Preferably, R⁵ is an optionally branched alkyl radical in the para position having 10 to 14 carbon atoms.

Particularly preferred blocked amines are selected from the group consisting of N,N′-bis(2,2-dimethyl-3-lauroyloxypropylidene)hexylene-1,6-diamine, N,N′-bis(2,2-dimethyl-3-acetoxypropylidene)-3-aminomethyl-3,5,5-trimethylcyclohexylamine, N,N′-bis(2,2-dimethyl-3-lauroyloxypropylidene)-3-aminomethyl-3,5,5-trimethylcyclohexylamine, N,N′-bis(4-C₁₀₋₁₄-alkylbenzylidene)-3-aminomethyl-3,5,5-trimethylcyclohexylamine, N,N′-bis(2,2-dimethyl-3-acetoxypropylidene)polyoxypropylenediamine having an average molecular weight Mₙ in the range from 450 to 880 g/mol, N,N′-bis(2,2-dimethyl-3-lauroyloxypropylidene)polyoxypropylenediamine having an average molecular weight Mₙ in the range from 750 to 1050 g/mol, N,N′-bis(4-C₁₀₋₁₄-alkylbenzylidene)polyoxypropylenediamine having an average molecular weight Mₙ in the range from 680 to 1100 g/mol, N,N′,N″-tris(2,2-dimethyl-3-acetoxypropylidene)polyoxypropylenetriamine having an average molecular weight Mₙ in the range from 730 to 880 g/mol, N,N′,N″-tris(2,2-dimethyl-3-lauroyloxypropylidene)polyoxypropylenetriamine having an average molecular weight Mₙ in the range from 1150 to 1300 g/mol and N,N′,N″-tris(4-C₁₀₋₁₄-alkylbenzylidene)polyoxypropylenetriamine having an average molecular weight Mₙ in the range from 1000 to 1350 g/mol.

The composition of the invention preferably contains at least one silane adhesion promoter. Organoalkoxysilanes are suitable for this purpose, in particular epoxysilanes, such as in particular 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes. The use of silane adhesion promoters especially improves adhesion to glass and ceramic substrates. The composition preferably contains between 0.1% and 1.0% by weight of silane adhesion promoter, based on the overall composition.

In preferred embodiments, the moisture-curing composition preferably contains between 10% and 30% by weight of nonthickening filler, based on the overall composition.

Nonthickening fillers are those fillers that have essentially no effect on rheology. By contrast, carbon black and silicas are counted among the thickening fillers.

Suitable nonthickening fillers are in particular ground or precipitated calcium carbonates, optionally coated with fatty acids, in particular stearates, barites, quartz flours, quartz sands, dolomites, wollastonites, calcined kaolins, sheet silicates, such as mica or talc, zeolites, aluminum hydroxides, magnesium hydroxides, graphite, metal powders, for example of aluminum, copper, iron, silver or steel, PVC powders or lightweight fillers such as hollow glass beads or gas-filled plastic spheres (microspheres), in particular the types obtainable under the Expancel® brand name (from Akzo Nobel).

Preference is given to calcium carbonates that have optionally been coated with fatty acids, especially stearates, and calcined kaolins.

In particularly preferred embodiments, the nonthickening filler is selected from chalk and kaolin and mixtures thereof.

Suitable plasticizers are in particular carboxylic esters, such as phthalates, in particular diisononyl phthalate (DINP), diisodecyl phthalate (DIDP) or di(2-propylheptyl)phthalate (DPHP), hydrogenated phthalates or cyclohexane-1,2-dicarboxylate esters, in particular hydrogenated diisononyl phthalate or diisononyl cyclohexane-1,2-dicarboxylate (DINCH), terephthalates, in particular bis(2-ethylhexyl)terephthalate (DOTP) or diisononyl terephthalate (DINT), hydrogenated terephthalates or cyclohexane-1,4-dicarboxylate esters, in particular hydrogenated bis(2-ethylhexyl) terephthalate or bis(2-ethylhexyl) cyclohexane-1,4-dicarboxylate, or hydrogenated diisononyl terephthalate or diisononyl cyclohexane-1,4-dicarboxylate, isophthalates, trimellitates, adipates, in particular dioctyl adipate, azelates, sebacates, benzoates, glycol ethers, glycol esters, plasticizers having polyether structure, in particular polypropylene oxide monools, diols or triols having blocked hydroxyl groups, in particular in the form of acetate groups, organic phosphoric or sulfonic esters, polybutenes, polyisobutenes or plasticizers derived from natural fats or oils, in particular epoxidized soybean or linseed oil.

Preferred plasticizers are phthalates or plasticizers having polyether structure.

Suitable diisocyanate oligomers are especially HDI biurets such as Desmodur® N 100 or N 3200 (from Covestro AG), Tolonate® HDB or HDB-LV (from Vencorex) or Duranate® 24A-100 (from Asahi Kasei); HDI isocyanurates such as Desmodur® N 3300, N 3600 or N 3790 BA (all from Covestro), Tolonate® HDT, HDT-LV or HDT-LV2 (from Vencorex), Duranate® TPA-100 or THA-100 (from Asahi Kasei) or Coronate® HX (from Tosoh Corp.); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/100 (from Evonik Industries); TDI oligomers such as Desmodur® IL (from Covestro); or mixed isocyanurates based on TDI/HDI, such as Desmodur® HL (from Covestro).

Suitable catalysts are catalysts for accelerating the reaction of isocyanate groups, in particular organotin(IV) compounds, such as, in particular, dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), in particular with ligands selected from alkoxides, carboxylates, 1,3-diketonates, oxinate, 1,3-ketoesterates, and 1,3-ketoamidates, or compounds containing tertiary amino groups, such as, in particular, 2,2′-dimorpholinodiethyl ether (DMDEE). If the moisture-curing composition contains blocked amines, suitable catalysts are also catalysts for the hydrolysis of the blocked amino groups, especially organic acids, especially carboxylic acids such as 2-ethylhexanoic acid, lauric acid, stearic acid, isostearic acid, oleic acid, neodecanoic acid, benzoic acid, salicylic acid or 2-nitrobenzoic acid, organic carboxylic anhydrides such as phthalic anhydride, hexahydrophthalic anhydride or methylhexahydrophthalic anhydride, silyl esters of carboxylic acids, organic sulfonic acids such as methanesulfonic acid, p-toluenesulfonic acid or 4-dodecylbenzenesulfonic acid, sulfonic esters, other organic or inorganic acids, or mixtures of the aforementioned acids and acid esters. Particular preference is given to carboxylic acids, in particular aromatic carboxylic acids, such as benzoic acid, 2-nitrobenzoic acid or in particular salicylic acid.

Also especially suitable are combinations of different catalysts.

Suitable stabilizers are in particular stabilizers against oxidation, heat, light or UV radiation, in particular titanium dioxides, iron oxides, zinc oxides, benzophenones, benzotriazoles, compounds having 2,6-di-tert-butylphenol groups, as known for example under the Irganox® trade name (from BASF), compounds having 2,2,6,6-tetramethylpiperidine groups, called HALS (hindered amine light stabilizers), as known for example under the Tinuvin® trade name (from BASF), or phosphorus-containing compounds as known for example under the Irgafos® trade name (from BASF).

The moisture-curing composition may contain further additions, especially
inorganic or organic pigments, in particular titanium dioxide, chromium oxides or iron oxides;
fibers, in particular glass fibers, carbon fibers, metal fibers, ceramic fibers, polymer fibers, such as polyamide fibers or polyethylene fibers, or natural fibers, such as wool, cellulose, hemp or sisal;
nanofillers such as graphene or carbon nanotubes;
dyes;
desiccants, in particular molecular sieve powders, calcium oxide, highly reactive isocyanates such as p-tosyl isocyanate, monooxazolidines such as Incozol® 2 (from Incorez) or orthoformic esters;
adhesion promoters, in particular organoalkoxysilanes, in particular epoxysilanes, such as in particular 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes, or titanates;
further catalysts that accelerate the reaction of the isocyanate groups;
rheology modifiers, in particular thickeners, in particular sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
solvents, in particular acetone, methyl acetate, tert-butyl acetate, 1-methoxy-2-propyl acetate, ethyl 3-ethoxypropionate, diisopropyl ether, diethylene glycol diethyl ether, ethylene glycol diethyl ether, ethylene glycol monobutyl ether, ethylene glycol mono-2-ethylhexyl ether, acetals such as propylal, butylal, 2-ethylhexylal, dioxolane, glycerol formal or 2,5,7,10-tetraoxaundecane (TOU), toluene, xylene, heptane, octane, naphtha, white spirit, petroleum ether or gasoline, in particular Solvesso™ grades (from Exxon), and propylene carbonate, dimethyl carbonate, butyrolactone, N-methylpyrrolidone, N-ethylpyrrolidone, p-chlorobenzotrifluoride or benzotrifluoride;
natural resins, fats or oils, such as rosin, shellac, linseed oil, castor oil or soybean oil;
nonreactive polymers, in particular homo- or copolymers of unsaturated monomers, in particular from the group comprising ethylene, propylene, butylene, isobutylene, isoprene, vinyl acetate or alkyl (meth)acrylates, in particular polyethylenes (PE), polypropylenes (PP), polyisobutylenes, ethylene/vinyl acetate copolymers (EVA) or atactic poly-α-olefins (APAO);
flame-retardant substances, especially the aluminum hydroxide or magnesium hydroxide fillers already mentioned, and also especially organic phosphoric esters, such as, in particular, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenylphosphate), bisphenol A bis(diphenylphosphate) or ammonium polyphosphates;
additives, in particular wetting agents, leveling agents, defoamers, deaerating agents or biocides;
   or further substances customarily used in moisture-curing polyurethane compositions.

It may be advisable to chemically or physically dry certain substances before mixing them into the composition.

Preferably, the composition of the invention contains little solvent. It especially contains less than 5% by weight, preferably less than 2.5% by weight, of solvent. Most preferably, the composition of the invention is essentially free of solvents.

The moisture-curing composition preferably contains
25% to 50% by weight of polymers P1,
optionally up to 1.5% by weight of polymer P2,
optionally up to 2% by weight of polymer P3,
21% to 25% by weight of carbon black,
10% to 30% by weight of nonthickening fillers,
10% to 20% by weight of plasticizers,
   and optionally further constituents, in particular silane adhesion promoters, blocked amines, diisocyanate oligomers, drying agents, catalysts and/or stabilizers, with the proviso that at least one of polymers P2 and P3 is present in the composition.

The moisture-curing composition preferably contains at least 0.5% by weight of polymer P2 and/or at least 0.5% by weight of polymer P3, based on the overall composition.

A particularly preferred embodiment of the composition of the invention contains between 0.5% and 1.5% by weight of polymer P2, based on the overall composition, and no polymer P3.

A further particularly preferred embodiment of the composition of the invention contains between 0.5% and 2.0% by weight of polymer P3, based on the overall composition, and no polymer P2.

A further particularly preferred embodiment of the composition of the invention contains between 0.5% and 1.5% by weight of polymer P2, based on the overall composition, and between 0.5% and 2.0% by weight of polymer P3, based on the overall composition.

In all embodiments, the moisture-curing composition preferably contains less than 0.1% by weight of monomeric diisocyanates. Such a composition can be transported and sold in many countries without hazardous substance classification.

The moisture-curing composition is especially produced with exclusion of moisture and stored at ambient temperature in moisture-tight containers. A suitable moisture-tight container especially consists of an optionally coated metal and/or plastic, and is especially a drum, a transport box, a hobbock, a bucket, a canister, a can, a bag, a tubular bag, a cartridge or a tube.

The moisture-curing composition is preferably a one-component composition. Given suitable packaging and storage, it is storage-stable, typically for several months up to one year or longer.

The moisture-curing composition begins to cure during and after application under the influence of moisture or water. To accelerate curing, an accelerator component containing water and optionally a catalyst and/or a curing agent can be mixed into the composition on application, or the composition, once it has been applied, can be contacted with such an accelerator component.

In the course of curing, the isocyanate groups react with one another under the influence of moisture. If the moisture-curing composition contains a blocked amine, the isocyanate groups additionally react with the blocked amino groups as they are hydrolyzed. The totality of these reactions of isocyanate groups that lead to the curing of the composition is also referred to as crosslinking. This results in the cured composition.

The moisture required for the curing of the composition preferably gets into the composition through diffusion from the air (atmospheric moisture). In the process, a solid layer of cured composition (“skin”) is formed on the surfaces of the composition which come into contact with air. Curing proceeds in the direction of diffusion from the outside inward, the skin becoming increasingly thick and ultimately covering the entire composition that was applied. The moisture can also get into the composition additionally or entirely from one or more substrate(s) to which the composition has been applied and/or can come from an accelerator component that is mixed into the composition on application or is contacted therewith after application, for example by painting or spraying.

The moisture-curing composition is preferably applied at ambient temperature or in slightly heated form, especially in the range from about −5 to 80° C., preferably in the range from 0 to 70° C., especially 25 to 65° C.

If polymer P2 is present, the moisture-curing composition is preferably applied in the heated state, for example at a temperature between 40° C. and 80° C. The moisture-curing composition is preferably cured at ambient temperature.

The moisture-curing composition has a long processing time (open time) and rapid curing.

“Open time” refers to the period of time during which the composition can be processed or reprocessed after application without any loss of its ability to function. If the composition is used as adhesive, the open time especially also refers to the period of time within which a bond must have been made after application thereof in order to develop sufficient adhesion. The open time has been surpassed at least when a skin has formed or when there is no longer sufficient buildup of adhesion to the substrates.

The moisture-curing composition is preferably used as elastic adhesive and/or sealant, especially for bonding or sealing applications in the construction and manufacturing industry or in motor vehicle construction, especially for parquet bonding, assembly, bonding of installable components, module bonding, pane bonding, join sealing, bodywork sealing, seam sealing or cavity sealing.

Elastic bonds in vehicle construction are, for example, the bonded attachment of parts such as plastic covers, trim strips, flanges, fenders, driver's cabins or other installable components to the painted body of a vehicle, or the bonding of panes into the vehicle body, said vehicles especially being automobiles, trucks, buses, rail vehicles or ships.

Particular preference is given to use as adhesive for the glazing of motor vehicles, especially for the replacement of glass in motor vehicles.

The moisture-curing composition is preferably formulated such that it has a pasty consistency, typically free-flowing under standard expression pressure, with structurally viscous properties at room temperature or in slightly heated form. A composition of this kind is applied by means of a suitable device, for example from commercial cartridges or drums or hobbocks, especially in the form of a bead, which may have an essentially round or triangular cross-sectional area.

Suitable substrates which can be bonded and/or sealed with the moisture-curing composition are especially
glass, glass ceramic or screenprinted ceramic-coated glass or polycarbonate;
metals or alloys, such as aluminum, copper, iron, steel, nonferrous metals, including surface-finished metals or alloys, such as zinc-plated or chromium-plated metals;
coated or painted substrates, especially powder-coated metals or alloys or painted sheet metal;
paints or varnishes, especially automotive topcoats;
cured adhesives, especially based on polyurethane, silane-modified polymer or polysulfide, especially aged adhesives (residual adhesive bead), or bodywork flange having residual adhesive bead everywhere or in places;
plastics, such as rigid or flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
repair compounds or leveling compounds based on PCC (polymer-modified cement mortar) or ECC (epoxy resin-modified cement mortar);
insulation foams, especially made of EPS, XPS, PUR, PIR, rock wool, glass wool or foamed glass;
concrete, mortar, cement screed, fiber cement, especially fiber cement boards, brick, tile, gypsum, especially gypsum boards or anhydride screed, or natural stone, such as granite or marble, painted tiles or painted concrete, asphalt or bitumen;
leather, textiles, paper, wood, wood materials bonded with resins, such as phenolic, melamine or epoxy resins, resin/textile composites or further materials called polymer composites.

The substrates can if required be pretreated prior to application, especially by physical and/or chemical cleaning methods or the application of an activator or a primer.

It is possible to bond and/or seal two identical or two different substrates.

The invention further provides a method of bonding or sealing, comprising the steps of
(i) applying the moisture-curing composition described
   to a first substrate and contacting the composition with a second substrate within the open time of the composition, or
   to a first and to a second substrate and joining the two substrates within the open time of the composition, or
   between two substrates,
(ii) curing the composition by contact with moisture.

At least one of the substrates is preferably selected from the group consisting of glass, glass ceramic, screenprinted ceramic-coated glass or polycarbonate, metals, alloys, powder-coated metals or alloys, paints and varnishes and cured adhesive, especially residual adhesive bead, and/or sheet metal painted with automotive topcoats.

The application and curing of the moisture-curing composition or the method of bonding or sealing affords an article bonded or sealed with the composition. This article may be a built structure or a part thereof, especially a built structure in civil engineering above or below ground, a bridge, a roof, a staircase or a façade, or it may be an industrial good or a consumer good, especially a window, a pipe, a rotor blade of a wind turbine, a domestic appliance or a mode of transport, such as especially an automobile, a bus, a truck, a rail vehicle, a ship, an aircraft or a helicopter, or an installable component thereof.

The invention thus further provides an article obtained from the described method of bonding or sealing.

Particular preference is given to using the method of bonding for the elastic bonding of glass panes to motor vehicles, especially for the replacement of glass, where good adhesion to residual adhesive bead is particularly important.

The moisture-curing composition has advantageous properties. It has particularly good bonding properties without a tendency to delamination, particularly good application properties, especially particularly good expressability coupled with high sag resistance, and particularly good initial strength without slippage of substrates, with unchanged good curing, strength, extensibility, elasticity and hazardous substance classification. The composition is thus particularly suitable as elastic adhesive in motor vehicle construction, especially for the insertion of windshields in vehicle construction or the replacement of defective windshields in automobiles for repair.

### EXAMPLES

Working examples are adduced hereinafter, which are intended to further elucidate the invention described. It will be apparent that the invention is not limited to these described working examples.

“Standard climatic conditions” (“SCC”) refer to a temperature of 23±1° C. and a relative air humidity (r.h.) of 50±5%.

The chemicals used were from Sigma-Aldrich Chemie GmbH, unless otherwise stated.

### Preparation of Polymers Containing Isocyanate Groups

Viscosity was measured using a thermostated Rheotec RC30 cone-plate viscometer (cone diameter 25 mm, cone angle 1°, cone tip-plate distance 0.5 mm, shear rate 50 s⁻¹).

Monomeric diisocyanate content was determined by HPLC (detection via photodiode array; 0.04 M sodium acetate/acetonitrile as mobile phase) after prior derivatization with N-propyl-4-nitrobenzylamine.

### Polymer P1-1 (Polymer P1a, Inventive):

727.0 g of Acclaim® 4200 (polyoxypropylene diol, OH number 28 mg KOH/g, from Covestro) and 273.0 g of diphenylmethane 4,4′-diisocyanate (Desmodur® 44 MC L, from Covestro) were converted by a known method to a polyether urethane polymer having an NCO content of 7.6% by weight, a viscosity of 5.2 Pa·s at 20° C. and a diphenylmethane 4,4′-diisocyanate content of about 18% by weight.

Subsequently, the volatile constituents, especially a majority of the diphenylmethane 4,4′-diisocyanate, were removed as described for polymer P1-1. The polyether urethane polymer thus obtained had an NCO content of 1.8% by weight, a viscosity of 15.2 Pa·s at 20° C. and a diphenylmethane 4,4′-diisocyanate content of 0.08% by weight.

### Polymer P1-2 (Polymer P1b, Inventive):

725.0 g of Desmophen® 5031 BT (glycerol-started ethylene oxide-terminated polyoxypropylene triol, OH number 28 mg KOH/g, from Covestro) and 275.0 g of diphenylmethane 4,4′-diisocyanate (Desmodur® 44 MC L, from Covestro) were converted by a known method to a polyether urethane polymer having an NCO content of 7.6% by weight, a viscosity of 6.5 Pa·s at 20° C. and a diphenylmethane 4,4′-diisocyanate content of about 20% by weight. Subsequently, the volatile constituents, especially a majority of the diphenylmethane 4,4′-diisocyanate, were removed by distillation in a short-path evaporator (jacket temperature 180° C., pressure 0.1 to 0.005 mbar, condensation temperature 47° C.). The polyether urethane polymer thus obtained had an NCO content of 1.7% by weight, a viscosity of 19 Pa·s at 20° C. and a diphenylmethane 4,4′-diisocyanate content of 0.04% by weight.

### Polymer P1Ra (Noninventive Linear Polyether Urethane Polymer):

400 g of polyoxypropylene diol (Acclaim® 4200, from Covestro AG; OH number 28.5 mg KOH/g) and 52 g of diphenylmethane 4,4′-diisocyanate (Desmodur® 44 MC L, from Covestro AG) were reacted by a known process at 80° C. to give an NCO-terminated polymer which is liquid at room temperature and has an isocyanate group content of 1.85% by weight and a monomeric diphenylmethane 4,4′-diisocyanate content of about 2.1% by weight.

### Polymer P1Rb (Noninventive Branched Polyether Urethane Polymer):

685 g of Voranol® CP 4755 (glycerol-started ethylene oxide-terminated polyoxypropylene triol, OH number 35.0 mg KOH/g, OH functionality about 2.4; from Dow), 115 g of diphenylmethane 4,4′-diisocyanate (Desmodur® 44 MC L, from Covestro) and 200 g of diisodecyl phthalate (DIDP) were converted by a known method at 80° C. to a polyether urethane polymer having an NCO content of 1.9% by weight and a monomeric diphenylmethane 4,4′-diisocyanate content of about 2.1% by weight. Because of the high viscosity of the polymer, it contains 20% by weight of DIDP that remains from the synthesis.

### Polymer P2-1 (Polymer P2, Inventive):

709.0 g of polyester diol (Dynacoll® 7360, semicrystalline, OH number 30.5 mg KOH/g, from Evonik) and 291.0 g of diphenylmethane 4,4′-diisocyanate (Desmodur® 44 MC L, from Covestro) were converted by a known method at 80° C. to a polymer having an NCO content of 7.8% by weight, a viscosity of 7.9 Pa·s at 60° C. and a monomeric diphenylmethane 4,4′-diisocyanate content of about 16% by weight.

Subsequently, the volatile constituents, especially a majority of the monomeric diphenylmethane 4,4′-diisocyanate, were removed by distillation in a short-path evaporator (jacket temperature 180° C., pressure 0.1 to 0.005 mbar, condensation temperature 47° C.). The room temperature solid polymer thus obtained had an NCO content of 1.8% by weight, a viscosity of 7.1 Pa·s at 100° C. and a monomeric diphenylmethane 4,4′-diisocyanate content of 0.2% by weight.

### Polymer P3-1 (Polymer P3, Inventive):

500.0 g of PTMG-650 (Terathane® 650, OH number 170 to 180 mg KOH/g, from Invista) and 750.0 g of diphenylmethane 4,4′-diisocyanate (Desmodur® 44 MC L, from Covestro) were converted by a known method at 80° C. to a polymer having an NCO content of 15.4% by weight (NCO/OH about 4/1).

Subsequently, the volatile constituents, especially a majority of the monomeric diphenylmethane 4,4′-diisocyanate, were removed by distillation in a short-path evaporator (jacket temperature 180° C., pressure 0.1 to 0.005 mbar, condensation temperature 47° C.). The room temperature liquid polymer thus obtained had an NCO content of 6.0% by weight and a monomeric diphenylmethane 4,4′-diisocyanate content of 0.05% by weight.

### Polymer P3-2 (Polymer P3, Inventive):

Polymer P3-2 was prepared just like polymer P3-1, except using, rather than 500.0 g of PTMG-650 as diol, 330 g of Voranol P 400 (Voranol® P 400, OH number 260 mg KOH/g, from Dow). The room temperature liquid polymer thus obtained had an NCO content of 4.0% by weight and a monomeric diphenylmethane 4,4′-diisocyanate content of 0.05% by weight.

Polymers P1-1 and P1-2 are polyether urethane polymers P1. Polymers P1Ra and P1Rb are comparable polyether urethane polymers but are not inventive (with regard to NCO/OH ratio). Polymer P2-1 is an inventive polymer P2. Polymers P3-1 and P3-2 are inventive polymers P3.

### Moisture-Curing Compositions:

### Compositions Z1 to Z17:

For each composition, the ingredients specified in tables 1 and 2 were well mixed in the amounts specified (in parts by weight) by means of a planetary mixer under reduced pressure and with exclusion of moisture, and the respective composition was dispensed into an aluminum cartridge with an airtight seal and stored at room temperature.

The results measurements as described below are likewise given in tables 1 and 2.

Compositions labeled “(Ref.)” are comparative examples.

Each composition was tested as follows:

A measure determined for the processibility or applicability of the composition was the expression force, i.e. the force required to express a composition from a cartridge. A low expression force means good processibility or applicability. Expression force was determined at 60° C. A first closed cartridge was stored at 23° C. for 7 days and then heated at 60° C. for 2 hours. Then the expression force was measured in each case by means of an expression device (Zwick/Roell Z005), by screwing a nozzle of internal diameter 3 mm onto the cartridge and then measuring the force required to express the composition through the nozzle at an expression rate of 60 mm/min. The value reported is the average of the forces that were measured after an expression distance of 22 mm, 24 mm, 26 mm and 28 mm. Values below 1200 N are considered to be adequate, and values below 1100 N to be good.

For determination of mechanical properties, each composition was pressed between two silicone-coated release papers to give a film of thickness 2 mm and stored under standard climatic conditions for 14 days. After removing the release papers, some test specimens were punched out and tested as described as follows:

For determination of tensile strength, elongation at break and modulus of elasticity at 0.5-5% elongation, dumbbells having a length of 75 mm with a bar length of 30 mm and a bar width of 4 mm were punched out of the film, and these were tested to DIN EN 53504 at a strain rate of 200 mm/min.

Further measurements were conducted to determine the tendency to slippage (slipdown), the compression force required in the bonding of substrates, and adhesion stability under tensile stress (delamination), in order to determine the suitability of a composition as adhesive as window adhesive in automobile manufacture.

Measurements of compression force were conducted by means of a Zwicki 1020 test instrument (Zwick Roell, Germany) and accompanying software (TestXpert Advanced Edition; Compression Force test program). For this purpose, an adhesive that had been heated at 60° C. in a cartridge for 2 h was applied to a polyethylene sheet (L×W×H=100 mm×40 mm×6 mm) in the form of a regular triangular bead over the total length. The adhesive bead had an original height of 10 mm, a base width of 8 mm and a length of 100 mm. Exactly 5 minutes after application of the adhesive bead at 23° C., 50% r.h., the sheet with the adhesive bead was inserted into the test instrument. A second test sheet of identical type was placed onto the adhesive bead such that the faces of the two test sheets lay parallel to one another and the sheets were aligned. The sheets were then compressed at a constant speed of 200 mm/min, and the compression force required was recorded until a compressed adhesive bead having a height of 4 mm and a width of 9 to 11 mm was obtained. Measurement by means of the test program gave the compression force needed to compress the adhesive to that thickness (in N/cm). The reported value is an average of at least 3 measurements. A relatively low compression force is preferred. Values below 4 N/cm are considered to be adequate.

Tendency to delamination (loss of adhesion under tensile stress) of a bond with a composition to be tested was examined as follows: A cartridge with the composition to be tested was heated in an oven at 60° C. for 2 hours prior to application of the test. During this period, two test sheets were prepared. The first test sheet made of float glass (250 mm×40 mm×4 mm) was pretreated on the air side with Sika® HydroPrep®-110 (water-based primer available from Sika Schweiz). The second test sheet, a steel plate (L×W×H=120 mm×50 mm×0.8 mm) coated by cathodic electrocoating, was cleaned with heptane. The coated steel plate was clamped horizontally in a holder. A triangular bead of the adhesive to be tested of length 100 mm was applied to the pretreated glass plate, and the plate with the bead, by means of 5 mm spacers, one minute after application, was pressed onto the clamped steel plate at 23° C./50% r.h., which compressed the adhesive bead. This compressed the original triangular bead between the two plates to a size of (L×W×H=) 100 mm×10 mm×5 mm. 2.5 minutes after the compression, by means of a screw, pressure buildup on one side (width) of the glass plate was commenced, such that the distance between the originally applied plates was increased on one side (width), and spreading and hence a tensile stress on one side was exerted on the bond. The dynamic increase in tensile stress resulted from a continuous increase in the distance between the two plates on one side (width) at 0.5 mm/20 s. After 6 minutes and 20 seconds from commencement of tensile strength, an additional distance of 10 mm was thus created continuously on one side (width) of the originally parallel plates. During this measurement, there was continuous monitoring of the distance (0 to 10 mm) from which the first delamination phenomena (detachment of the adhesive from the steel plate) were apparent. The evaluation was according to the following scheme:
No noticeable delamination up to a distance of 10 mm: “OK”
Delamination begins at a distance of between 5 and 10 mm: “moderate”
Delamination begins before a distance of 5 mm: “high”.

What are desired are values classified as “OK”, i.e. measurements that do not show delamination (loss of adhesion) of the bond.

For the measurement of slipdown (vertical slippage characteristics of a substrate in the freshly applied adhesive), a square metal plate (L×W=320 mm×320 mm) was provided, which had a weight of 4200 g. Decorator's adhesive tape was applied along the edges on one face of that plate. A triangular bead of the adhesive to be tested was applied to all four edges of the decorator's adhesive tape while the plate lay on a balance. It was ensured that a total of 80 g of the adhesive to be tested was applied (20 g for each edge per triangular bead). The triangular beads each had a base width of about 10 mm and a height of about 10 mm. The adhesive had been subjected to heat treatment in the cartridge beforehand at 60° C. for 2 h and was applied directly in the warm state. The measurement was conducted in a climate-controlled space (23° C., 50% r.h.). 30 seconds after application of the adhesive bead, the plate with the adhesive applied was pressed onto a vertically fixed second square plate (L×W=400 mm×400 mm), which additionally has spacers (5 mm), in such a way that the two plate faces came to lie parallel and the faces of the plates faced vertically downward. The adhesive bead between the plates was compressed to a thickness of 5 mm with the aid of the spacers, while the first, unfixed plate was at first stabilized against slippage downward. 30 seconds after compression of the adhesive between the plates (60 seconds after application of the adhesive bead), the apparatus stabilizing the first unfixed plate was removed and the measurement of the slippage characteristics was measured by means of a digital distance measuring device (Sony U30A). The distance by which the unfixed first plate slipped subsequently under its own weight is described by slipdown (in mm). What are desired are low slipdown values, with values below 0.5 mm considered to be adequate and values below 0.4 mm to be good.

The results are reported in tables 1 and 2.

Compositions labeled “(Ref.)” are comparative examples.

The data in tables 1 and 2 show that only the compositions of the invention have all these properties in combination. At the same time, the compositions of the invention have good mechanical properties (tensile strength and elongation at break) and hence optimal suitability as elastic structural adhesives.

Compositions having an expression force of <1200 N, a compression force <4 cm, a slipdown of <0.5 mm and delamination classified as “OK” are of optimal suitability as adhesives for the automobile industry, especially as window adhesives. They have good applicability for automotive applications, and good initial strength and good adhesion stability.

Compositions containing less than 20% by weight of carbon black show too high a slipdown.

TABLE 1
Composition (in parts by weight) and properties of Z1 to Z8.

| | | | Z3 | Z4 | Z5 | Z6 | Z7 | Z8 |
|---|---|---|---|---|---|---|---|---|
| Composition | Z1 | Z2 | (Ref.) | (Ref.) | (Ref.) | (Ref.) | (Ref.) | (Ref.) |
| Polymer P1-1 | 33.5 | 33.5 | — | — | — | — | — | — |
| Polymer P1-2 | 9.0 | 9.0 | — | — | — | — | — | — |
| Polymer PR1a | — | — | 31 | 33.5 | 33.5 | 30 | 30 | 30 |
| Polymer PR1b ⁶ | — | — | 22 | 9.0 | 9.0 | 21 | 21 | 21 |
| Polymer P3-1 | 1.5 | 1.5 | — | 1.5 | 1.5 | — | — | — |
| Oligomer ¹ | 2.5 | 2.5 | 2.5 | 2.5 | 2.5 | 2.5 | 2.5 | 2.5 |
| Epoxysilane ² | 0.2 | 0.2 | 0.2 | 0.2 | 0.2 | 0.2 | 0.2 | 0.2 |
| Plasticizer ³ | 15.8 | 12.3 | 9.7 | 15.8 | 12.3 | 11.7 | 12.7 | 13.7 |
| Dryer ⁴ | 0.1 | 0.1 | 0.1 | 0.1 | 0.1 | 0.1 | 0.1 | 0.1 |
| Carbon black | 23 | 23 | 25 | 23 | 23 | 24 | 23 | 22 |
| Kaolin | 13.5 | — | 8.6 | 13.5 | — | 9.6 | 9.6 | 9.6 |
| Chalk | — | 17.0 | — | — | 17.0 | — | — | — |
| Catalyst ⁵ | 0.9 | 0.9 | 0.9 | 0.9 | 0.9 | 0.9 | 0.9 | 0.9 |
| Expression force | 981 | 1067 | 1600 | 1310 | 1468 | 1376 | 1081 | 879 |
| [N] | | | | | | | | |
| Slipdown [mm] | 0.3 | 0.2 | 0.2 | 0.2 | 0.3 | 0.2 | 0.5 | 0.9 |
| Compression force | 2.7 | 3.1 | n.d. | n.d. | n.d. | n.d. | n.d. | n.d. |
| [N/cm] | | | | | | | | |
| Tensile strength | 10.4 | 9.8 | 12 | n.d. | n.d. | n.d. | n.d. | n.d. |
| [MPa] | | | | | | | | |
| Elongation at break | 416 | 479 | 412 | n.d. | n.d. | n.d. | n.d. | n.d. |
| [%] | | | | | | | | |
| Modulus of | 8.3 | 8.8 | 11.3 | n.d. | n.d. | n.d. | n.d. | n.d. |
| elasticity [MPa] | | | | | | | | |
| Delamination [—] | OK | OK | OK | OK | OK | OK | OK | OK |

¹ HDI trimer (isocyanurate)
² 3-glycidoxypropyltrimethoxysilane
³ diisononyl phthalate (DINP)
⁴ tosyl isocyanate
⁵ dioctyltin diketanoate 4% by weight in DINP
⁶ contains 20% by weight of DIDP
“n.d.” stands for “not determined”.

TABLE 2
Composition (in parts by weight) and properties of Z9 to Z17.

| | Z9 | Z10 | | | | | | Z16 | Z17 |
|---|---|---|---|---|---|---|---|---|---|
| Composition | (ref.) | (ref.) | Z11 | Z12 | Z13 | Z14 | Z15 | (ref.) | (ref.) |
| Polymer P1-1 | — | 34.0 | 32.5 | 31 | 32.0 | 33.25 | 33.5 | 32.0 | — |
| Polymer P1-2 | — | 9.0 | 9.0 | 9.0 | 9.0 | 9.0 | 9.0 | 8.0 | 36.8 |
| Polymer PR1a | 33.5 | — | — | — | — | — | — | — | — |
| Polymer PR1b ⁶ | 8 | — | — | — | — | — | — | — | — |
| Polymer P2-1 | 3.0 | — | — | — | 0.5 | 0.75 | — | — | 2.5 |
| Polymer P3-1 | — | — | 1.5 | 3.0 | 1.5 | — | — | 1.0 | — |
| Polymer P3-2 | — | — | — | — | — | — | 1.5 | — | 2.0 |
| Oligomer ¹ | 2.5 | 2.5 | 2.5 | 2.5 | 2.5 | 2.5 | 2.5 | 2.5 | — |
| Epoxysilane ² | 0.2 | 0.1 | 0.1 | 0.1 | 0.1 | 0.1 | 0.1 | 0.2 | — |
| Plasticizer ³ | 20.8 | 14.2 | 14.2 | 14.2 | 14.2 | 14.2 | 12.6 | 12.3 | 18.8 |
| Dryer ⁴ | 0.1 | — | — | — | — | — | — | 0.1 | 0.1 |
| Carbon black | 22.5 | 23.0 | 23.0 | 23.0 | 23.0 | 23.0 | 23.0 | 18.0 | 18.5 |
| Kaolin | 8.5 | — | — | — | — | — | — | — | — |
| Chalk | — | 16.5 | 16.5 | 16.5 | 16.5 | 16.5 | 17.0 | 25.0 | 21.5 |
| Catalyst ⁵ | 0.9 | 0.7 | 0.7 | 0.7 | 0.7 | 0.7 | 0.9 | 0.9 | — |
| Expression force [N] | 530 | 807 | 992 | 1004 | 951 | 877 | 1097 | 491 | 412 |
| Slipdown [mm] | 0.2 | 1.8 | 0.2 | 0.2 | 0.2 | 0.3 | 0.1 | * | 5.0 |
| Compression force | 4.0 | 2.1 | 2.8 | 3.1 | 2.9 | 2.5 | 3.7 | 1.3 | n.d. |
| [N/cm] | | | | | | | | | |
| Tensile strength | 8.8 | 10.3 | 10.5 | 9.9 | 10.3 | 9.7 | 12.1 | 6.8 | 8.22 |
| [MPa] | | | | | | | | | |
| Elongation at break | 321 | 556 | 554 | 431 | 521 | 518 | 546 | 412 | 589 |
| [%] | | | | | | | | | |
| Modulus of elasticity | 9.1 | 7.8 | 8.4 | 9.2 | 8.7 | 8.6 | 11.1 | 6.2 | 5.48 |
| [MPa] | | | | | | | | | |
| Delamination [—] | high | OK | OK | OK | OK | OK | OK | OK | n.d. |

¹ HDI trimer (isocyanurate)
² 3-glycidoxypropyltrimethoxysilane
³ diisononyl phthalate (DINP)
⁴ tosyl isocyanate
⁵ dioctyltin diketanoate 4% by weight in DINP
⁶ contains 20% by weight of DIDP
* Test plate slipped down immediately (massive slipdown).
“n.d.” stands for “not determined”.

1. A moisture-curing polyurethane composition comprising
at least one polyether urethane polymer P1 containing isocyanate groups and having a monomeric diisocyanate content of not more than 0.5% by weight, obtained from the reaction of at least one monomeric diisocyanate with at least one polyether polyol having an average molecular weight Mₙ of more than 2500 g/mol in an NCO/OH ratio of at least 3/1, and subsequent removal of a majority of the monomeric diisocyanate by means of a suitable separation method, and
more than 20% by weight of carbon black, based on the overall composition, and
optionally not more than 2% by weight of a room temperature solid polyurethane polymer P2, based on the overall composition, obtained from the reaction of at least one monomeric diisocyanate with at least one at least semicrystalline polyester polyol or polycarbonate polyol in an NCO/OH ratio of at least 1.3/1, and
optionally up to 5% by weight of a polyether urethane polymer P3, based on the overall composition, obtained from the reaction of at least one monomeric diisocyanate with at least one polyether diol having an average molecular weight Mₙ of not more than 2500 g/mol in an NCO/OH ratio of at least 1.3/1,
with the proviso that at least one of the polymers P2 and P3 is present in the composition.

2. The moisture-curing composition as claimed in claim 1, wherein at least one polymer P1 has an NCO content in the range from 1% to 5% by weight and at least 80% by weight of 1,2-propyleneoxy units in the polyether segment.

3. The moisture-curing composition as claimed in claim 1, wherein the isocyanate groups of polymers P1, P2 and/or P3 are derived from diphenylmethane 4,4′-diisocyanate.

4. The moisture-curing composition as claimed in claim 1, wherein polymer P1 comprises at least one polymer P1a obtained from a polyether diol, and at least one polymer P1b obtained from a polyether triol.

5. The moisture-curing composition as claimed in claim 1, wherein the composition comprises between

20. 5% and 25% by weight of carbon black, based on the overall composition.

6. The moisture-curing composition as claimed in claim 1, wherein the composition contains between 0.5% and 1.5% by weight of polymer P2, based on the overall composition.

7. The moisture-curing composition as claimed in claim 1, wherein the composition contains between 0.5% and 2% by weight of polymer P3, based on the overall composition.

8. The moisture-curing composition as claimed in claim 7, wherein polymer P3 is based on poly(oxy-1,4-butylene)diol.

9. The moisture-curing composition as claimed in claim 1, wherein the composition contains between 10% and 30% by weight of nonthickening filler, based on the overall composition.

10. The moisture-curing composition as claimed in claim 9, wherein the nonthickening filler is selected from chalk and kaolin and mixtures thereof.

11. The moisture-curing composition as claimed in claim 1, wherein at least one further constituent selected from silane adhesion promoters, blocked amines, diisocyanate oligomers, drying agents, catalysts and stabilizers is additionally present.

12. The moisture-curing composition as claimed in claim 11, wherein it contains, based in each case on the overall composition,
25% to 50% by weight of polymers P1,
optionally up to 1.5% by weight of polymer P2,
optionally up to 2% by weight of polymer P3,
21% to 25% by weight of carbon black,
10% to 30% by weight of nonthickening fillers,
10% to 20% by weight of plasticizers,
and optionally further constituents, with the proviso that at least one of polymers P2 and P3 is present in the composition.

13. The moisture-curing composition as claimed in claim 11, wherein the composition contains at least 0.5% by weight of polymer P2 and/or at least 0.5% by weight of polymer P3, based on the overall composition.

14. A method of bonding or sealing, comprising the steps of
(i) applying the moisture-curing composition as claimed in claim 1
to a first substrate and contacting the composition with a second substrate within the open time of the composition, or
to a first and to a second substrate and joining the two substrates within the open time of the composition, or
between two substrates,
(ii) curing the composition by contact with moisture.

15. An article obtained from the method as claimed in claim 14.
